(19) United States
(12) Patent Application Publication
(10) Pub. No.: US 2018/0158030 A1
(43) Pub. Date: Jun. 7, 2018

(54) AUTOMATIC MEETING INVITE PROCESSING

(71) Applicant: Microsoft Technology Licensing, LLC, Redmond, WA (US)

(72) Inventors: Sina HAKAMI, Bothell, WA (US); Jaskaran SINGH, Redmond, WA (US); Julia FORAN, Seattle, WA (US)

(73) Assignee: Microsoft Technology Licensing, LLC, Redmond, WA (US)

(21) Appl. No.: 15/496,745

(22) Filed: Apr. 25, 2017

Related U.S. Application Data
(60) Provisional application No. 62/429,303, filed on Dec. 2, 2016.

(51) Int. Cl. G06Q 10/10

(52) U.S. Cl. CPC G06Q 10/1095; G06Q 10/107

(57) ABSTRACT

Examples of the present disclosure describe systems and methods relating to an automatic meeting invite processor. When processing a meeting invite, the automatic meeting invite processor may enforce a calendar booking rule, which may be comprised by a predicate and an action. The predicate may specify characteristics relating to the meeting invite, such as a sender, scheduled date/time, scheduled location, etc. The predicate may also relate to context associated with a recipient of the meeting invite (e.g., the recipient's calendar or mailbox content). When a predicate is satisfied, the automatic meeting invite processor may perform one or more actions, wherein an action may relate to the meeting specified by the meeting invite or to the meeting invite object itself. Thus, when the predicate is satisfied, the meeting invite may be automatically processed by the automatic meeting invite processor using the action specified by the calendar booking rule.

### CROSS-REFERENCE TO RELATED APPLICATIONS

This application claims the benefit of and claims priority to U.S. Provisional Patent Application No. 62/429,303, filed Dec. 2, 2016 and entitled “AUTOMATIC MEETING INVITE PROCESSING,” the disclosure of which is hereby incorporated by reference herein in its entirety.

### BACKGROUND

A calendaring system may be used by members of an organization to schedule events and appointments. Within the calendaring system, some meeting invites may be more notable than others (e.g., a regular weekly project group status meeting versus a mandatory company-wide meeting led by a C-level executive). However, the calendaring system may process such meeting invites similarly, and may provide recipients with the same options regardless of meeting invite characteristics. As such, regardless of the meeting characteristics, a recipient may perform traditional calendaring system actions (e.g., accept, tentatively accept, reject, etc.) or leave the meeting invite unhandled (e.g., merely marking the meeting invite as read or deleting the invite without adding it to a calendar).

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods related to automatic meeting invite processing. The automatic meeting invite processor may be used to create and enforce one or more calendar booking rules. A calendar booking rule may comprise a predicate and an action. More specifically, the predicate may specify characteristics relating to a meeting invite, including, but not limited to, a sender, a scheduled date/time, a scheduled location, etc. In other examples, the predicate may relate to context associated with a recipient of the meeting invite. As an example, the calendar booking predicate may specify one or more conditions relating to the scheduling availability of the recipient or the content of the recipient's mailbox.

Upon determining that the predicate is satisfied, the automatic meeting invite processor may perform one or more actions, wherein an action may relate to the meeting specified by the meeting invite (e.g., accept the meeting, tentatively accept the meeting, reject the meeting, etc.), or the action may relate to the meeting invite object itself (e.g., mark the meeting invite as read, delete the meeting invite, forward the meeting invite, etc.). As such, the meeting invite may be automatically processed by the automatic meeting invite processor using the action as a result of determining that the predicate was satisfied.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for a multi-tenant environment comprising an automatic meeting invite processor.

FIG. 2 illustrates an overview of an example method for applying a transport rule.

FIG. 3 illustrates an overview of an example method for applying a calendar booking rule.

FIG. 4 illustrates an overview of an example method for creating a transport rule comprising a calendar booking rule.

FIG. 5 illustrates an overview of an example system comprising an automatic meeting invite processor.

FIG. 6 illustrates an overview of an example system comprising an automatic meeting invite processor.

FIG. 7 is a block diagram illustrating example physical components of a computing device with which aspects of the disclosure may be practiced.

FIG. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods relating to automatic meeting invite processing. The automatic meeting invite processor may be a component within a calendaring system. The calendar booking system may enable the creation of system-wide or organizational-wide calendar booking rules, thereby ensuring that meeting invites having one or more specified characteristics are uniformly handled by recipients. For example, an organization may specify that all meeting invitations sent by a specific sender should be automatically accepted (e.g., meeting invites sent by a CEO or a university registrar's office should be automatically accepted on behalf of the recipient).

The calendaring system may be comprised of a variety of components, including, but not limited to one or more transport agents, one or more delivery agents, and one or more mailboxes. A transport agent may process and route meeting invites sent by or addressed to users of the calendaring system. In order to deliver a meeting invite, the transport agent may provide the meeting invite to a delivery agent. The delivery agent may then further process the meeting invite and ultimately deliver the meeting invite to one or more mailboxes or calendars associated with addressees of the meeting invite. The calendaring booking assistant may use various components of the calendaring system (e.g., a transport agent, a delivery agent, etc.) to process and enforce calendar booking rules.

In some examples, the calendaring system may be part of an enterprise software suite (e.g., it may be provided with or as a part of an email message handling system). Further, the calendaring system may be a distributed system, wherein at least one server provides calendaring services to at least one client. As an example, the server may store and make available one or more user mailboxes using a software package such as MICROSOFT EXCHANGE SERVER, while a user may remotely access a mailbox using a client software package such as MICROSOFT OUTLOOK. Further, the transport agent and delivery agent may reside on a server. In another example, at least one of the transport agent, the delivery agent, and the user mailbox may reside on a client, wherein at least some aspect of meeting invite transmission and delivery is handled by the client rather than a server. One of skill in the art will appreciate that the technical implementation and underlying software comprising the calendaring system may be varied without departing from the spirit of this disclosure.

The calendaring system may be, at least in part, a software as a service (SaaS) product, wherein one or more computing resources comprising at least a portion of the calendaring system are made available remotely to an organization by a service provider. The organization may use a locally-installed software client to access the remote computing resources (e.g., MICROSOFT OUTLOOK, IBM NOTES, APPLE CALENDAR, etc.). In another example, the organization may access the calendaring system using a remotely-accessible software solution, including, but not limited to, a web interface provided by the service provider (e.g., MICROSOFT OUTLOOK WEB ACCESS, GOOGLE CALENDAR, etc.). As a result, the service provider may configure and manage the remote computing resources, while the organization need only configure access to the provided computing resources.

In some SaaS systems, a service provider may employ a multi-tenant computing environment, wherein at least some of the same computing resources are used to provide services to multiple organizations. More specifically, at least some of the same calendaring system components may be used when processing at least a subset of meeting invites for different tenants within the multi-tenant environment. As an example, there may be at least one common transport agent or delivery agent. In other examples, a tenant may have one or more unshared transport agents and/or delivery agents within the multi-tenant calendaring system.

Returning to the automatic meeting invite processor, a calendar booking rule may be comprised of a calendar booking predicate and a calendar booking action. The calendar booking rule may be evaluated by a delivery agent when delivering a meeting invite to a recipient's mailbox or calendar. In an example, the calendar booking rule may be evaluated by a transport agent, or by a combination of the delivery agent and the transport agent. The calendar booking predicate may specify one or more conditions that must be satisfied before the calendar booking action may be performed. In some examples, the calendar booking predicate may specify characteristics relating to the meeting invite, including, but not limited to, a sender, a scheduled date/time, a scheduled location, etc. In other examples, the calendar booking predicate may relate to context associated with a recipient. As an example, the calendar booking predicate may specify one or more conditions relating to scheduling availability. In another example, the calendar booking predicate may evaluate the content of a recipient's mailbox (e.g., whether there is an email message from a specific sender, etc.). One of skill in the art will appreciate that context associated with a recipient may relate to a variety of characteristics and attributes associated with a mailbox, mailbox folders, one or more calendars, scheduling availability, and specific appointments or messages, among others, without departing from the spirit of this disclosure.

The calendar booking action may specify one or more actions to perform when it is determined that the calendar booking predicate is satisfied. As an example, an action may relate to the meeting specified by the meeting invite (e.g., accepting the meeting, tentatively accepting the meeting, rejecting the meeting, etc.), or an action may relate to the meeting invite object itself (e.g., mark the meeting invite as read, delete the meeting invite, forward the meeting invite, etc.). In some examples, an action may create a new object based on the meeting invite, such as a notification, a reminder, or another meeting invite, among others.

Information relating to a calendar booking rule may be associated with a transport rule, which may be comprised of a transport predicate and a transport action. In some examples, the transport rule may be further comprised of the calendar booking rule. The transport rule may be stored within a transport ruleset. When processing incoming meeting invites, a transport agent may evaluate transport rules stored by the transport ruleset. In some examples, there may be a plurality of transport agents, each having an associated transport ruleset. In other examples, multiple transport agents may evaluate transport rules from the same transport ruleset.

The transport predicate may specify one or more conditions that must be satisfied before the transport action may be performed. Similar to the calendar booking predicate discussed above, the transport predicate may specify characteristics relating to the meeting invite, including, but not limited to, a sender, a scheduled date/time, a scheduled location, etc. The transport action may specify one or more actions to perform when it is determined that the transport predicate is satisfied. As an example, the transport action may specify that the calendar booking rule should be associated with the meeting invite. In some examples, associating the calendar booking rule with the meeting invite may comprise storing at least a subpart of the calendar booking rule in the metadata associated with the meeting invite (e.g., in a header field).

More specifically, a calendar booking rule may be stored in the meeting invite as a JavaScript Object Notation (JSON) object, wherein the JSON object contains information relating to a calendar booking predicate and a calendar booking action. The JSON object may be stored in a header of the meeting invite (for example, an X-MS-Exchange-Organization-PersonalBooking header). In some examples, multiple headers comprising a plurality of calendar booking rules stored as JSON objects may be added to a meeting invite. In other examples, multiple calendar booking rules may be stored in the same JSON object and the same meeting invite header. When a delivery agent receives a meeting invite, it may then retrieve one or more JSON objects from one or more headers within a meeting invite and parse the JSON objects, thereby retrieving the information relating to calendar booking rules that were stored within the meeting invite. One of skill in the art will appreciate that other techniques may be used to store one or more calendar booking rules within a meeting invite without departing from the spirit of this disclosure.

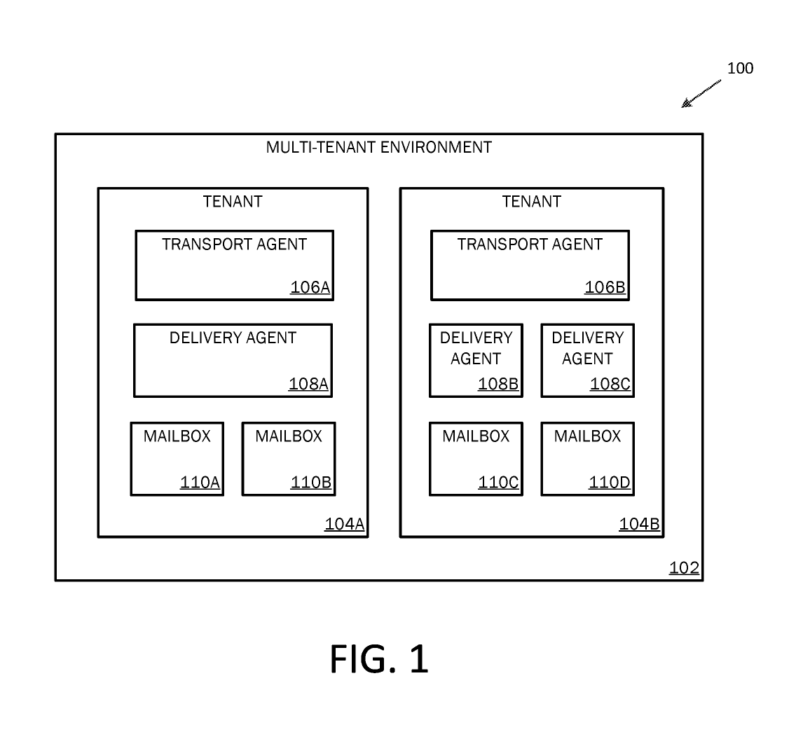

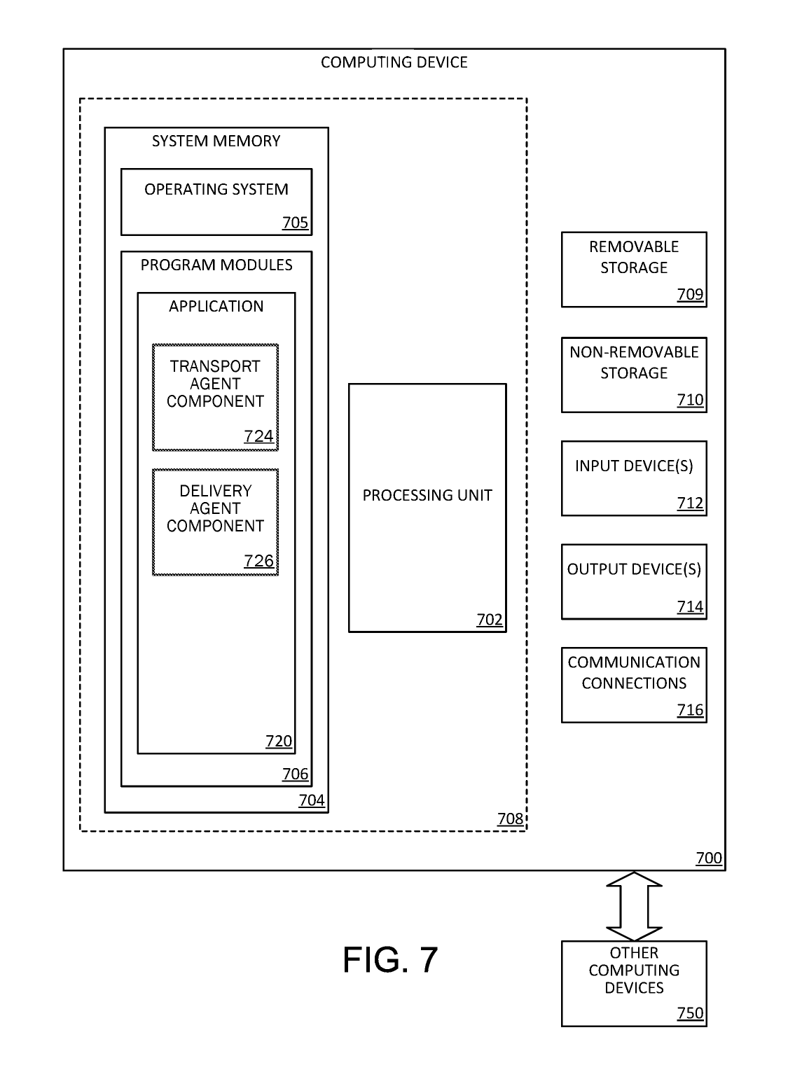

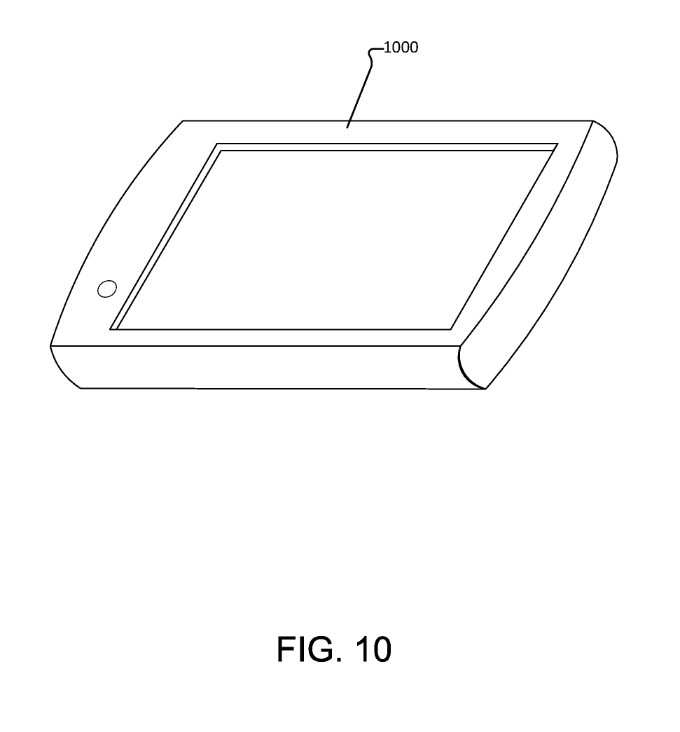

FIG. 1 illustrates an overview of an example system for a multi-tenant environment comprising an automatic meeting invite processor. System 100 may be a combination of interdependent components that interact to form a multi-tenant calendaring system provided by a service provider as a SaaS product. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 7-10. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 is comprised of multi-tenant environment 102. Multi-tenant environment 102 may be a computing environment containing computing resources which are used by tenant 104A and tenant 104B as a SaaS calendaring system. Tenant 104A may be comprised of transport agent 106A, delivery agent 108A, and mailbox 110A and 110B. Similarly, tenant 104B may be comprised of transport agent 106B, delivery agent 108B and 108C, and mailbox 110C and 110D. Transport agent 106A and 106B may each access a transport ruleset (not pictured) that is specific to tenant 104A and 104B. In another example, computing resources and data may be shared between tenant 104A and 104B. As an example, tenant 104A and 104B may access a transport ruleset that is associated with each tenant. In another example, tenant 104A and 104B may share access to data relating to the calendaring system, including, but not limited to, user mailboxes (e.g., mailbox 110A-110D), mailbox content, and incoming meeting invites. Use of the shared resources may vary depending on the needs of each tenant and/or on the utilization and processing requirements of the calendaring system.

When a meeting invite is received by multi-tenant environment 102, transport agent 106A may receive and process the meeting invite if the recipient's mailbox is mailbox 110A or 110B. Similarly, transport agent 106B may receive and process the meeting invite if the recipient's mailbox is mailbox 110C or 110D. Processing the meeting invite by transport agent 106A or 106B may comprise evaluating one or more transport rules stored in a transport ruleset. A transport rule may be comprised of a transport predicate and a transport action. A transport predicate may specify characteristics relating to the meeting invite, including, but not limited to, a sender, a scheduled date/time, a scheduled location, etc. If it is determined by transport agent 106A or 106B that a transport predicate associated with a transport rule applies, the transport action associated with the transport rule may be performed. Performing the transport action may comprise associating a calendar booking rule associated with the transport rule with the meeting invite. In some examples, the calendar booking rule may be stored in the meeting invite as a header. If there are multiple applicable calendar booking rules, multiple headers may be added or subsequent calendar booking rules may be appended to the same header in the meeting invite.

In some examples, transport agent 106A or 106B may modify the meeting invite to remove properties which may otherwise interfere with the automatic meeting invite processor. In an example, transport agent 106A or 106B may remove one or more headers in the meeting invite which would otherwise be set by a transport rule, an original sender, or a calendaring system used by the original sender. More specifically, the transport agent may remove potentially malicious or fraudulent properties from the meeting invite such that later components of the calendaring system are assured that the meeting invite properties are trustworthy. As a result, when the meeting invite is received by a delivery agent (e.g., delivery agent 108A-108C), the delivery agent may extract and process the meeting invite properties with certainty as to their origin.

Transport agent 106A may then transmit the meeting invite to delivery agent 108A. Similarly, transport agent 106B may transmit the meeting invite to delivery agent 108B or 108C, based on a determination of which delivery agent should receive the meeting invite. The determination may be based on meeting invite characteristics, including, but not limited to, the meeting invite recipient (e.g., whether recipient's mailbox is mailbox 110C or 110D) or the content of an associated transport rule and/or calendar booking rule.

Delivery agent 108A-108C may then further process the meeting invite, based on the calendar booking rule that was associated with the meeting invite by transport agent 106A or 106B. The calendar booking rule may comprise a calendar booking predicate and a calendar booking action. In some examples, delivery agent 108A-108C may extract a calendar booking rule from the meeting invite (e.g., from a header or other metadata stored within the meeting invite). As an example, a calendar booking rule may be stored as a JSON object within the meeting invite.

When evaluating a calendar booking predicate associated with a calendar booking rule, delivery agent 108A-108C may evaluate context associated with a recipient of the meeting invite, including context associated with the recipient's mailbox (e.g., one of mailbox 110A-110D). If delivery agent 108A-108C determines that the calendar booking predicate is satisfied, the calendar booking action associated with the calendar booking rule may be performed by delivery agent 108A-108C. In some examples, the action may relate to the meeting specified by the meeting invite (e.g., accepting the meeting, tentatively accepting the meeting, rejecting the meeting, etc.), or the action may relate to the meeting invite object itself (e.g., mark the meeting invite as read, delete the meeting invite, forward the meeting invite, etc.). Delivery agent 108A-108C may then deliver the meeting invite to mailbox 110A-110D accordingly (e.g., accepting the meeting by adding it to the recipient's calendar, marking the meeting invite as read, among others).

In some examples, a single transport agent may be used for multiple tenants within a multi-tenant environment. As a result, the transport agent may evaluate properties relating to a meeting invite when determining which transport ruleset to apply when processing the meeting invite. For example, the transport agent may select and apply a different transport ruleset based on the sender, recipient (e.g., a specific mailbox), or tenant associated with the meeting invite. In another example, the transport agent may use the same transport ruleset to process a meeting invite regardless of whether the meeting invite is directed to a different sender, recipient, or tenant. Similarly, a plurality of tenants may share one delivery agent, wherein the delivery agent is responsible for processing and delivering messages to mailboxes that are associated with different tenants.

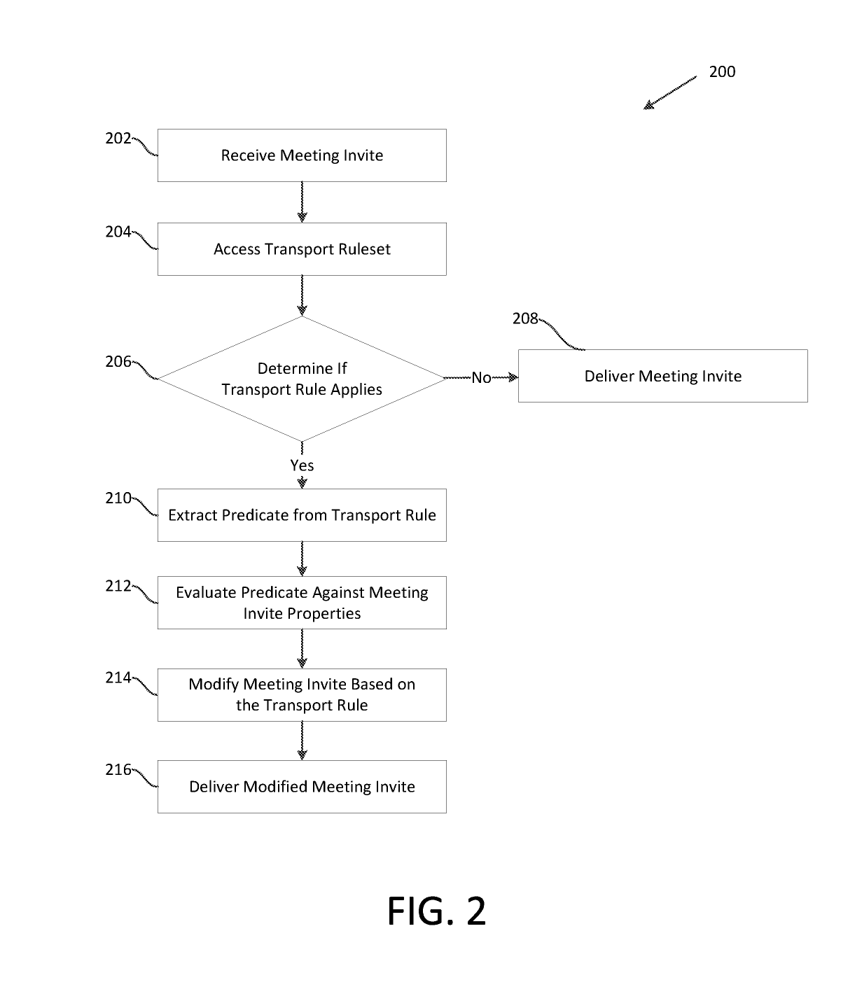

FIG. 2 illustrates an overview of an example method 200 for applying a transport rule, which may be comprised of a calendar booking rule. Method 200 may be performed by a transport agent within a calendaring system, such as transport agent 106A and 106B in FIG. 1. In some examples, method 200 may be performed by a delivery agent within a calendaring system, such as delivery agent 108A-108C. In other examples, method 200 may be performed by a combination of one or more transport agents and one or more delivery agents. The method begins at operation 202, where a meeting invite may be received. The meeting invite may be received from a sender that is external to the calendaring system, or the sender may be within the calendaring system.

At operation 204, a transport ruleset may be accessed. The transport ruleset may contain one or more transport rules. A transport rule may be comprised of a transport predicate and a transport action. Accessing the transport ruleset may comprise selecting a specific transport ruleset depending on characteristics associated with the meeting invite (e.g., a sender, a schedule time, a scheduled location, etc.). In some examples, a specific transport ruleset may be associated with a specific transport agent. In other examples, the transport ruleset may be accessed by a plurality of transport agents.

Moving to decision operation 206, a determination may be made as to whether a transport rule contained in the transport ruleset accessed by operation 204 applies to the meeting invite. If it is determined that there are no transport rules that apply to the meeting invite, flow branches NO to operation 208, where the meeting invite may be delivered. In some examples, delivering the meeting invite may comprise delivering the meeting invite to a delivery agent (e.g., delivery agent 108A-108C in FIG. 1) for further processing. Flow then terminates.

If, however, it is determined at decision operation 206 that a transport rule applies to the meeting invite, flow branches YES to operation 210. At operation 210, a transport predicate may be extracted from the transport rule. The transport predicate may specify one or more conditions that must be satisfied before a transport action associated with the transport rule may be performed. The transport predicate may specify characteristics relating to the meeting invite, including, but not limited to, a sender, a scheduled date/time, a scheduled location, etc.

At operation 212, the transport predicate extracted at operation 210 may be evaluated against one or more properties of the meeting invite. In some examples, the properties may be headers stored in or as properties of the meeting invite. Evaluating the properties may comprise performing exact or fuzzy matching based on the content of the transport predicate. As an example, the transport predicate may specify a specific sender which may be compared to the sender of the meeting invite. In another example, the transport predicate may specify a range of dates and/or times that may be compared against the scheduled date/time of the meeting invite. In a further example, a partial sender may be identified by the transport predicate (e.g., using a regular expression or other pattern-matching technique).

Moving to operation 214, the meeting invite may be modified based on the transport action specified by the transport rule. More specifically, the action specified by the transport action may be performed. In an example, the transport action may specify that a calendar booking rule associated with the transport rule should be associated with the meeting invite. As a result, the calendar booking rule may be associated with the meeting invite. In some examples, associating the calendar booking rule may comprise storing the calendar booking rule in a header of the meeting invite. The calendar booking rule may be stored using a variety techniques, including, but not limited to, generating a JSON representation of the calendar booking rule and storing the JSON representation in a header of the meeting invite. In another example, the calendar booking rule may be stored in a storage system and referenced using a unique identifier. The unique identifier may then be stored in the meeting invite (e.g., in a header field) to facilitate later retrieval of the calendar booking rule from the storage system.

Flow terminates at operation 216, where the modified meeting invite may be delivered. In some examples, delivering the meeting invite may comprise delivering the meeting invite to a delivery agent for further processing. In some examples, the meeting invite may be directed to at least one of a plurality delivery agents based on one or more properties associated with the meeting invite. As an example, the meeting invite may be directed to a specific delivery agent based on a recipient specified by the meeting invite, or a mailbox associated with the recipient.

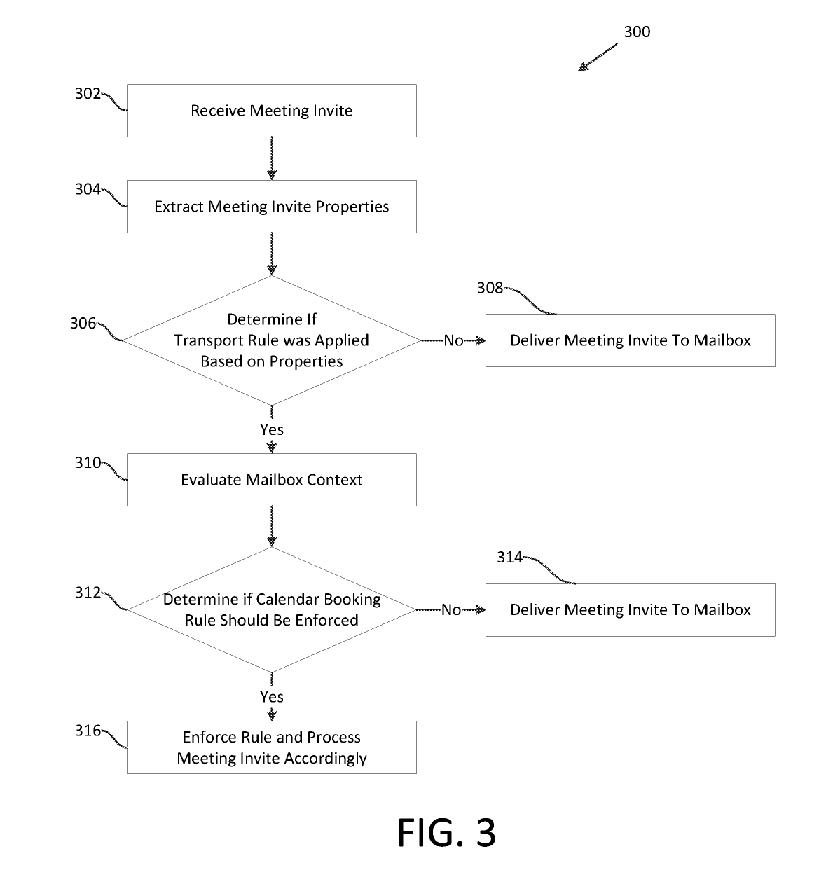

FIG. 3 illustrates an overview of an example method 300 for applying a calendar booking rule. Method 300 may be performed by a delivery agent within a calendaring system such as delivery agent 108A-108C in FIG. 1. Flow begins at operation 302 where a meeting invite may be received. The meeting invite may be received from a transport agent (e.g., transport agent 106A and 106B). In some examples, the meeting invite may have been provided to the delivery agent as a result of executing the steps of method 200 in FIG. 2.

At operation 304, properties may be extracted from the meeting invite. The properties may comprise a sender, a scheduled date/time, and a scheduled location, among others. In some examples, the properties may comprise one or more calendar booking rules which were added to the meeting invite as a result of performing a transport action associated with a transport rule. In an example, the properties may be headers contained within the meeting invite. In another example, the properties may comprise a reference identifier that is associated with a calendar booking rule stored separate from the meeting invite (e.g., by a storage system), wherein the resource identifier may be used to retrieve at least a part of the calendar booking rule.

Moving to decision operation 306, a determination may be made whether a transport rule was applied to the meeting invite based on the properties extracted in operation 304. The determination may be based on whether a calendar booking rule or information associated with a calendar booking rule is present within the extracted properties. If it is determined that a transport rule was not applied, flow branches NO to operation 308, where the meeting invite may be delivered to a mailbox associated with a recipient specified by the meeting invite. Flow then terminates.

If, however, at decision operation 306 it is determined that a transport rule was applied, flow branches YES to operation 310 where mailbox context may be evaluated. Evaluating mailbox context may comprise evaluating context associated with a recipient of the meeting invite. In some examples, the context may comprise characteristics or attributes associated with a mailbox, mailbox folders, one or more calendars, scheduling availability, and specific appointments or messages, among others.

Moving to decision operation 312, a determination is made whether the calendar booking rule extracted in operation 304 should be enforced. The calendar booking rule may be comprised of a calendar booking predicate and a calendar booking action. The determination may comprise evaluating the calendar booking predicate. In some examples, the calendar booking predicate may be evaluated in conjunction with the context that was evaluated in operation 310. For example, the calendar booking predicate may specify a condition relating to the scheduling availability of a recipient. The scheduling availability was evaluated in operation 310, and the result of the evaluation may be compared against the calendar booking predicate in order to, at least in part, determine whether the calendar booking rule should be enforced. In other examples, the characteristics of the meeting invite may be evaluated using the calendar booking predicate. As an example, the calendar booking predicate may specify a sender. The specified sender may be evaluated against the sender associated with the meeting invite as part of the determination whether the calendar booking rule should be enforced. In another example, the determination may be based on fuzzy or inexact matching.

If, at decision operation 312, it is determined that the calendar booking rule should not be enforced, flow branches NO to operation 314 where the meeting invite may be delivered to a mailbox associated with a recipient specified by the meeting invite. Flow then terminates.

If, however, it is determined at decision operation 312 that the calendar booking rule should be enforced, flow branches YES to operation 316 where the calendar booking rule may be enforced and the meeting invite may be processed accordingly. In some examples, enforcing the calendar booking rule may comprise performing an action specified by a calendar booking action associated with the calendar booking rule. The calendar booking action may specify one or more actions to perform, wherein an action may relate to the meeting specified by the meeting invite (e.g., accepting the meeting, tentatively accepting the meeting, rejecting the meeting, etc.), or an action may relate to the meeting invite object itself (e.g., mark the meeting invite as read, delete the meeting invite, forward the meeting invite, etc.). As a result of performing the calendar booking action, the meeting invite may be automatically added (e.g., accepted or tentatively accepted) to a recipient's calendar. In another example, the meeting invite may be automatically rejected and/or deleted. In yet another example, the meeting invite may be placed in the user's mailbox, where the meeting invite may be marked as read or forwarded to a different recipient. Flow terminates at operation 316.

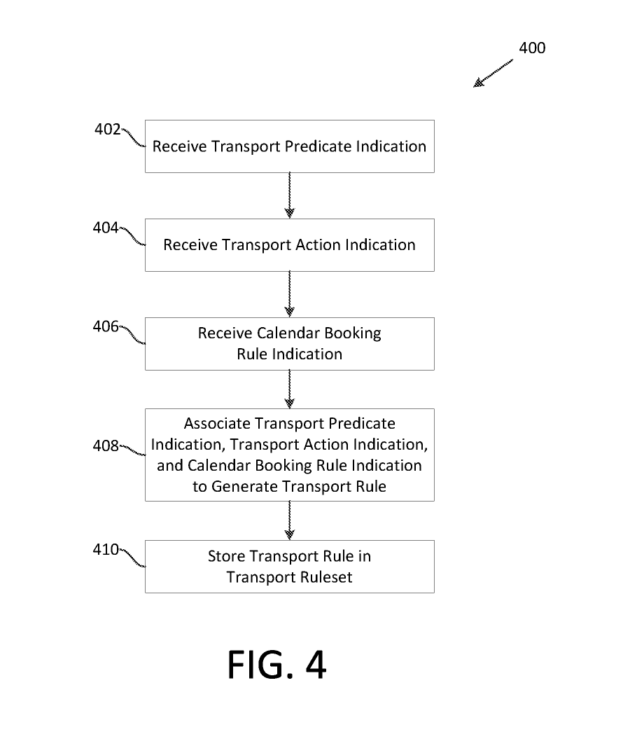

FIG. 4 illustrates an overview of an example method 400 for creating a transport rule comprising a calendar booking rule. An automatic meeting invite processor may use a transport rule in order to apply a system-wide calendar booking rule. More specifically, the transport rule may be used to associate a calendar booking rule with a meeting invite when it is received, if characteristics of the meeting invite satisfy a transport predicate associated with the transport rule. Other components of the calendaring system (e.g., a delivery agent) may then apply and enforce the calendar booking rule when the meeting invite is ultimately delivered to a mailbox associated with a recipient of the meeting invite. This ensures that the calendar booking rule is applied system-wide and enables a calendaring system to evaluate not only characteristics associated with the meeting invite (e.g., a sender, a date/time, etc., as may be evaluated by a transport agent), but also context associated with a recipient of the meeting invite (e.g., mailbox and calendar context, etc., as may be evaluated by a delivery agent).

In some examples, a calendaring system may generate a calendar booking rule using machine learning or other artificial intelligence techniques. As an example, the calendaring system may determine that a user tends to take one or more specific actions when user context and/or a meeting invite characteristics exhibit one or more specific conditions (e.g., rejecting invites which are scheduled around 12:00, accepting invites from a supervisor, relocating meetings which are not scheduled to occur at a nearby meeting location, among others). As a result of this determination, the calendaring system may generate a calendar booking rule to perform a determined action on behalf of the user. In another example, the calendaring system may prompt the user before implementing the calendar booking rule. One of skill in the art will appreciate that an array of user behaviors and actions relating to user context and meeting invite characteristics may be detected and evaluated without departing from the spirit of this disclosure.

Returning to FIG. 4, method 400 begins at operation 402 where a transport predicate indication is received. The transport predicate indication may specify one or more conditions that may be evaluated by a transport agent (e.g., transport agent 106A and 106B in FIG. 1). The transport predicate indication may specify characteristics relating to a meeting invite, including, but not limited to, a sender, a scheduled date/time, or a scheduled location, among others. At operation 404, a transport action indication may be received. The transport action indication may specify an action to perform when it is determined that the transport predicate received at operation 402 is satisfied. As an example, the transport action may specify that a calendar booking rule should be associated with a meeting invite. In some examples, the indication may specify that associating the calendar booking rule with the meeting invite may comprise storing at least a subpart of the calendar booking rule in the metadata associated with the meeting invite (e.g., in a header field).

Moving to operation 406, a calendar booking rule indication may be received. The calendar booking rule indication may comprise an indication relating to a calendar booking predicate and a calendar booking action. The calendar booking predicate may specify one or more conditions that must be satisfied before the calendar booking action may be performed. In some examples, the calendar booking predicate may specify characteristics relating to a meeting invite, including, but not limited to, a sender, a scheduled date/time, a scheduled location, etc. In other examples, the calendar booking predicate may relate to context associated with a recipient. As an example, the calendar booking predicate may specify one or more conditions relating to scheduling availability. In another example, the calendar booking predicate may evaluate the content of a recipient's mailbox (e.g., whether there is an email message from a specific sender, etc.). The calendar booking rule may be evaluated and enforced by a delivery agent (e.g., delivery agent 108A-108C in FIG. 1).

At operation 408, the transport predicate received at operation 402, the transport action received at operation 404, and the calendar booking rule received at operation 406 may be associated, thereby generating a transport rule. In some examples, the transport rule may be used by a transport agent when processing a meeting invite.

Moving to operation 410, the transport rule may be stored in a transport ruleset. Storing the transport rule in the transport ruleset may comprise storing the transport predicate, transport action, and calendar booking rule together. The transport ruleset may be stored by a calendaring system. In some examples, the transport ruleset may be stored by or associated with a transport agent. In another example, the transport rule and transport predicate may be stored together in the transport ruleset, while the calendar booking rule may be stored separately and instead associated with the transport predicate and transport action (e.g., using a resource identifier). One of skill in the art will appreciate that the transport action, transport rule, and calendar booking rule may be associated and/or stored for later access using a variety of techniques without departing from the spirit of this disclosure. Flow terminates at operation 410.

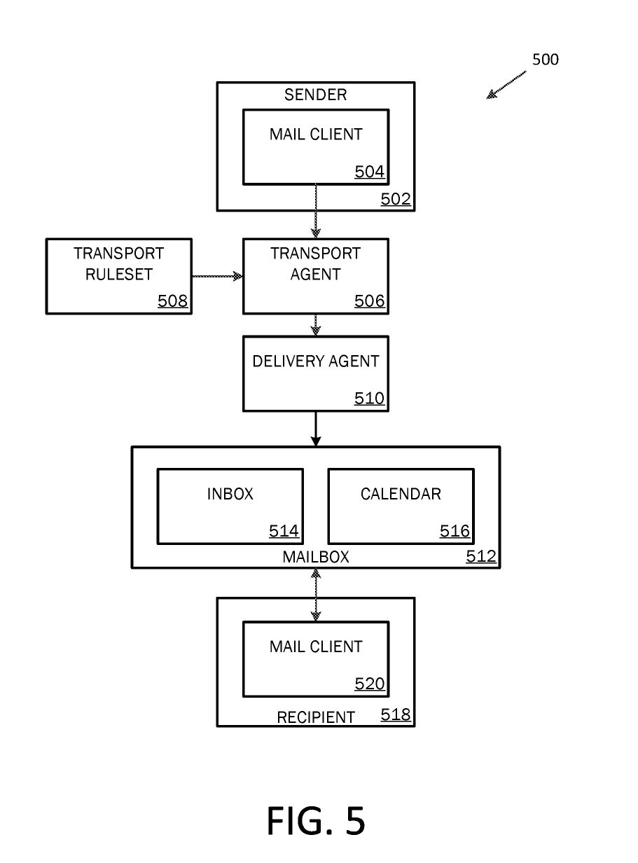

FIG. 5 illustrates an overview of an example system 500 comprising an automatic meeting invite processor. System 500 may be a combination of interdependent components that interact, wherein each component may be a separate computing device. In another example, one or more components may be the same computing device. System 500 may be comprised of sender 502 and recipient 518. Sender 502 may use mail client 504 and, similarly, recipient 518 may use mail client 520. In some examples, mail client 504 and 520 may be a software package which provides calendaring functionality such as MICROSOFT OUTLOOK, MICROSOFT OUTLOOK WEB ACCESS, IBM NOTES, APPLE CALENDAR, or GOOGLE CALENDAR. Sender 502 may use mail client 504 to send one or more meeting invites to recipient 518.

The meeting invites may be received by transport agent 506, which may be part of a calendaring system. When processing a meeting invite, transport agent 506 may evaluate one or more transport rules stored by transport ruleset 508. Transport ruleset 508 may be stored within the calendaring system, or may be stored by or associated with transport agent 506. Evaluating a transport rule may comprise executing method 200 as depicted in FIG. 2 and described in greater detail above. After processing the meeting invite (e.g., applying any applicable transport rules contained in transport ruleset 508), the meeting invite may be provided by transport agent 506 to delivery agent 510.

Delivery agent 510 may also be part of the calendaring system, and may evaluate and enforce a calendar booking rule, if applicable. Evaluating and enforcing a calendar booking rule may comprise executing method 300 as depicted in FIG. 3 and described in greater detail above. More specifically, delivery agent 510 may extract a calendar booking rule from the properties of the meeting invite and evaluate the calendar booking rule against context associated with mailbox 512. The context may comprise characteristics and attributes relating to inbox 514 and/or calendar 516. Based on the evaluation of the calendar booking rule in conjunction with the evaluated context, delivery agent 510 may perform an action, including, but not limited to, delivering the meeting invite to inbox 514, adding the meeting invite to calendar 516, or deleting the meeting invite such that the invite is not in inbox 514. This is discussed in greater detail above with respect to FIG. 3.

Recipient 518 may use mail client 520 to access information stored in mailbox 512 (e.g., inbox 514 and calendar 516). More specifically, recipient 518 may receive the meeting invite sent by sender 504 using mail client 520 by accessing mailbox 512. However, recipient 518 may not need to perform any additional action, as the calendar booking rule associated with the transport rule stored by transport ruleset 508 and applied by transport agent 506 has already instructed the automatic meeting invite processor (e.g., comprised by transport agent 506 and delivery agent 510) to process the meeting invite accordingly.

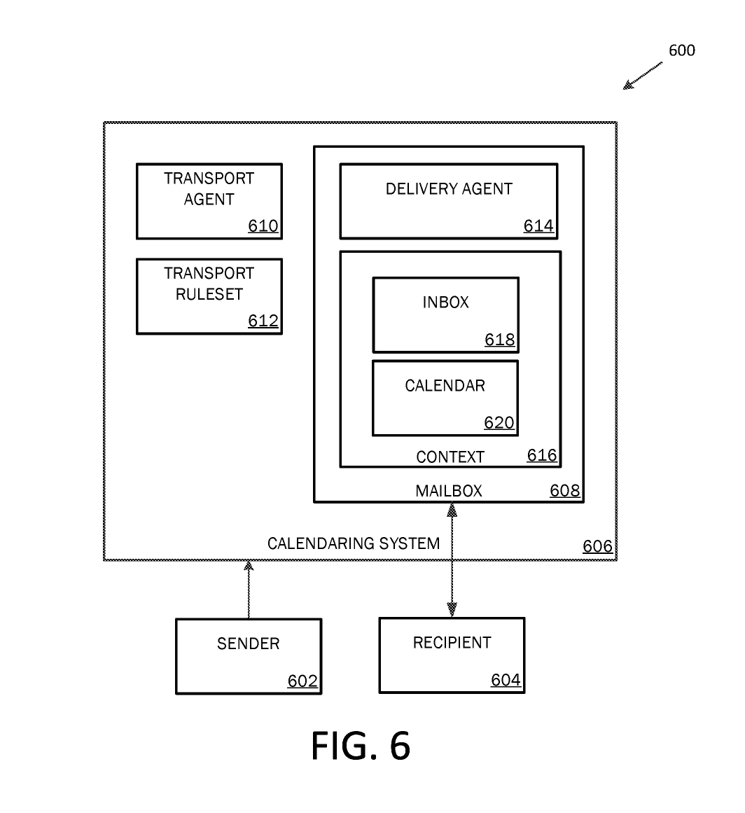

FIG. 6 illustrates an overview of an example system 600 comprising an automatic meeting invite processor. System 600 may be a combination of interdependent components that interact, wherein each component may be a separate computing device. In another example, one or more components may be the same computing device. System 600 may be comprised of sender 602 and recipient 604. Sender 602 may send one or more meeting invites to recipient 604 by way of calendaring system 606.

Calendaring system 606 is comprised of transport agent 610, transport ruleset 612, and mailbox 608. Transport ruleset 612 may be associated with transport agent 610. Mailbox 608 may be associated with a recipient of a meeting invite. Mailbox 608 may be comprised by delivery agent 614 and context 616. Delivery agent 614 may access and evaluate context 616 when processing and enforcing a calendar booking rule associated with a meeting invite. Context 616 may be comprised of characteristics and attributes relating to inbox 618 and calendar 620. In some examples, context 616 may be comprised of characteristics and attributes relating to calendaring system 606. In other examples, when calendaring system 606 is provided as part of an enterprise software suite (not pictured), context 616 may be comprised of characteristics and attributes relating information stored by the enterprise software suite.

When a meeting invite is received by calendaring system 606 (e.g., from sender 602), transport agent 610 may process the meeting invite. Processing a meeting invite may comprise evaluating one or more transport rules stored by transport ruleset 612. When evaluating a transport rule, transport agent 610 may execute method 200 as depicted in FIG. 2 and described in greater detail above. After processing the meeting invite (e.g., applying any applicable transport rules contained in transport ruleset 612), the meeting invite may be provided by transport agent 610 to delivery agent 614 for delivery into mailbox 608.

Delivery agent 614 and may evaluate and enforce a calendar booking rule, if applicable. Evaluating and enforcing a calendar booking rule may comprise executing method 300 as depicted in FIG. 3 and described in greater detail above. More specifically, delivery agent 614 may extract a calendar booking rule from the properties of the meeting invite and evaluate the calendar booking rule against context 616 associated with mailbox 608. Context 616 may comprise characteristics and attributes relating to inbox 618 and/or calendar 620. Based on the evaluation of the calendar booking rule in conjunction with the evaluated context, delivery agent 614 may perform an action, including, but not limited to, delivering the meeting invite to inbox 618, adding the meeting invite to calendar 620, or deleting the meeting invite such that the invite is not in mailbox 608. This is discussed in greater detail above with respect to FIG. 3.

Recipient 604 may access information stored in mailbox 608 (e.g., inbox 618 and calendar 620). More specifically, recipient 604 may receive the meeting invite sent by sender 602 from calendaring system 606 using calendaring software (e.g., MICROSOFT OUTLOOK, MICROSOFT OUTLOOK WEB ACCESS, IBM NOTES, APPLE CALENDAR, GOOGLE CALENDAR, etc.). Recipient 604 may not need to perform any additional action, as the calendar booking rule associated with the transport rule stored by transport ruleset 612 and applied by transport agent 610 has already instructed the automatic meeting invite processor (e.g., comprised by transport agent 610 and delivery agent 614) to process the meeting invite accordingly.

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for performing the various aspects disclosed herein such as transport agent component 724 and delivery agent component 726. The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

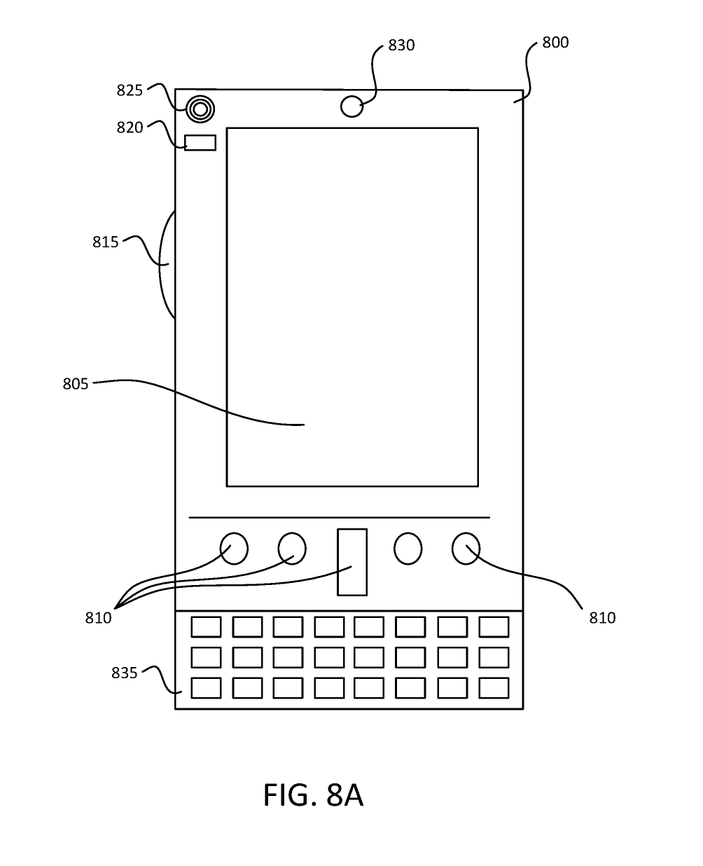

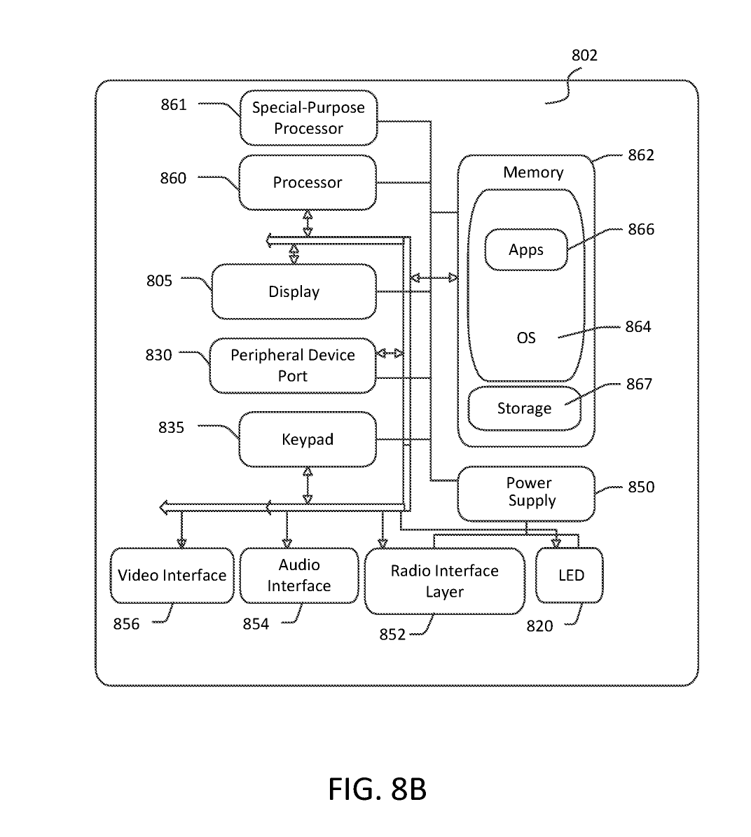

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g., search engine, extractor module, relevancy ranking module, answer scoring module, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

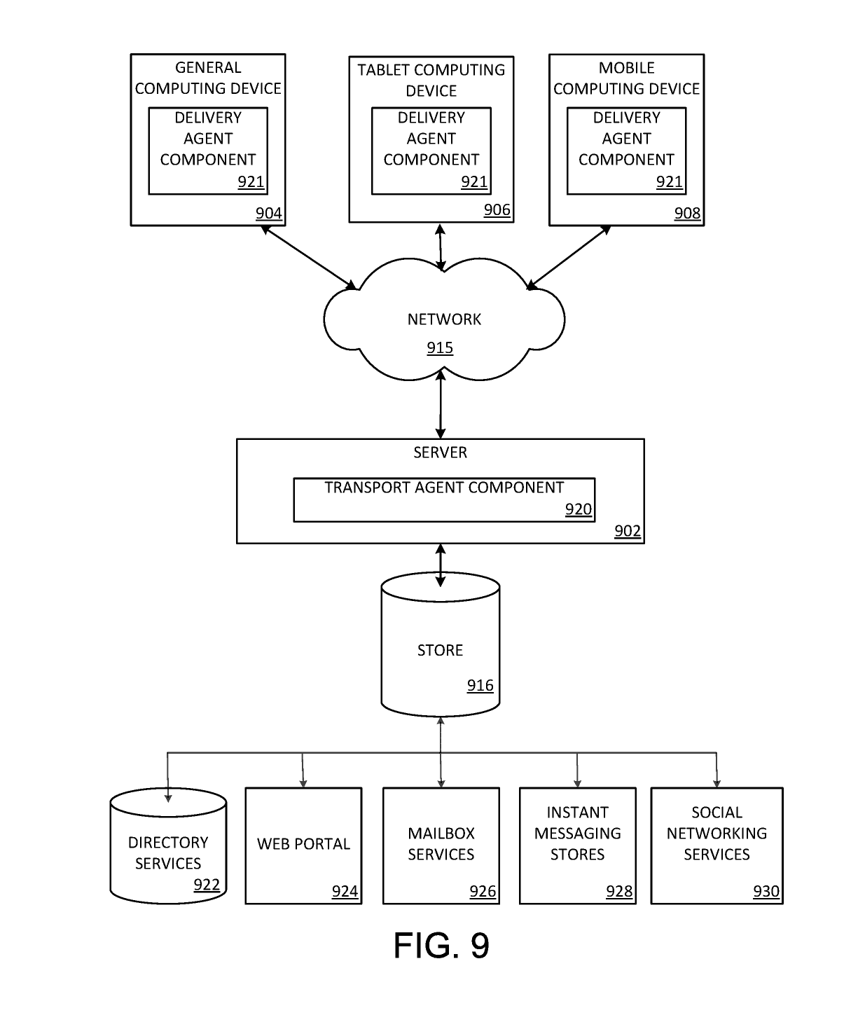

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. Delivery agent component 921 may be employed by a client that communicates with server device 902, and/or transport agent component 920 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and a memory storing instructions that when executed by the at least one processor perform a set of operations. The operations comprise receiving a meeting invite; accessing a transport rule associated with the meeting invite, wherein the transport rule is comprised of a transport predicate, a transport action, and a calendar booking rule; determining, based on the content of the meeting invite, whether the transport predicate is satisfied; and when the transport predicate is satisfied, modifying the meeting invite based on the transport action, wherein modifying the meeting invite comprises associating the calendar booking rule with the meeting invite. In an example, the transport action comprises updating a header associated with the meeting invite to contain information associated with the calendar booking rule. In another example, the transport predicate specifies a sender associated with the meeting invite. In yet another example, the calendar booking rule comprises a calendar booking predicate and a calendar booking action. In a further example, the calendar booking predicate comprises a predicate associated with the transport predicate. In one example, the calendar booking action comprises an action selected from the group consisting of: accepting the meeting invitation; tentatively accepting the meeting invitation; rejecting the meeting invitation; marking the meeting invitation as read; and deleting the meeting invitation. In a further example, associating the calendar booking rule with the meeting invite comprises storing the calendar booking rule in a header of the meeting invite.

In another aspect, the technology relates to another system comprising: at least one processor; and a memory storing instructions that when executed by the at least one processor perform a set of operations. The operations comprise receiving the meeting invite; extracting one or more properties from the meeting invite; determining, based on the one or more properties, that a calendar booking rule applies to the meeting invite, wherein the calendar booking rule comprises a calendar booking predicate and a calendar booking action; evaluating the calendar booking predicate to determine whether the calendar booking predicate is satisfied; and when the calendar booking predicate is satisfied, performing the action specified by the calendar booking action. In an example, evaluating the calendar booking predicate comprises evaluating a mailbox context associated with a mailbox for a recipient of the meeting invite. In another example, evaluating the calendar booking predicate comprises evaluating a scheduling availability associated with a recipient of the meeting invite. In yet another example, the calendar booking predicate specifies a sender associated with the meeting invite. In a further example, the calendar booking action comprises an action selected from the group consisting of: accepting the meeting invitation; tentatively accepting the meeting invitation; rejecting the meeting invitation; marking the meeting invitation as read; and deleting the meeting invitation. In one example, the one or more properties are headers within the meeting invite. In another example, the calendar booking rule is stored in the meeting invite as one or more headers.

In another aspect, the technology relates to a computer-implemented method for processing a meeting invite. The method comprises receiving a meeting invite; accessing a transport rule associated with the meeting invite, wherein the transport rule is comprised of a transport predicate, a transport action, and a calendar booking rule; determining, based on the content of the meeting invite, whether the transport predicate is satisfied; and when the transport predicate is satisfied, modifying the meeting invite based on the transport action, wherein modifying the meeting invite comprises associating the calendar booking rule with the meeting invite. In an example, the transport action comprises updating a header associated with the meeting invite to contain information associated with the calendar booking rule. In another example, the transport predicate specifies a sender associated with the meeting invite. In a further example, the calendar booking rule comprises a calendar booking predicate and a calendar booking action. In yet another example, the calendar booking action comprises an action selected from the group consisting of: accepting the meeting invitation; tentatively accepting the meeting invitation; rejecting the meeting invitation; marking the meeting invitation as read; and deleting the meeting invitation. In one example, associating the calendar booking rule with the meeting invite comprises storing the calendar booking rule in a header of the meeting invite.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
a memory storing instructions that when executed by the at least one processor perform a set of operations comprising:
receiving a meeting invite;
accessing a transport rule associated with the meeting invite, wherein the transport rule is comprised of a transport predicate, a transport action, and a calendar booking rule;
determining, based on the content of the meeting invite, whether the transport predicate is satisfied; and
when the transport predicate is satisfied, modifying the meeting invite based on the transport action, wherein modifying the meeting invite comprises associating the calendar booking rule with the meeting invite.

2. The system of claim 1, wherein the transport action comprises updating a header associated with the meeting invite to contain information associated with the calendar booking rule.

3. The system of claim 1, wherein the transport predicate specifies a sender associated with the meeting invite.

4. The system of claim 1, wherein the calendar booking rule comprises a calendar booking predicate and a calendar booking action.

5. The system of claim 4, wherein the calendar booking predicate comprises a predicate associated with the transport predicate.

6. The system of claim 4, wherein the calendar booking action comprises an action selected from the group consisting of:
accepting the meeting invitation;
tentatively accepting the meeting invitation;
rejecting the meeting invitation;
marking the meeting invitation as read; and
deleting the meeting invitation.

7. The system of claim 1, wherein associating the calendar booking rule with the meeting invite comprises storing the calendar booking rule in a header of the meeting invite.

8. A system comprising:
at least one processor; and
a memory storing instructions that when executed by the at least one processor perform a set of operations comprising:
receiving the meeting invite;
extracting one or more properties from the meeting invite;
determining, based on the one or more properties, that a calendar booking rule applies to the meeting invite, wherein the calendar booking rule comprises a calendar booking predicate and a calendar booking action;
evaluating the calendar booking predicate to determine whether the calendar booking predicate is satisfied; and
when the calendar booking predicate is satisfied, performing the action specified by the calendar booking action.

9. The system of claim 8, wherein evaluating the calendar booking predicate comprises evaluating a mailbox context associated with a mailbox for a recipient of the meeting invite.

10. The system of claim 8, wherein evaluating the calendar booking predicate comprises evaluating a scheduling availability associated with a recipient of the meeting invite.

11. The system of claim 8, wherein the calendar booking predicate specifies a sender associated with the meeting invite.

12. The system of claim 8, wherein the calendar booking action comprises an action selected from the group consisting of:
accepting the meeting invitation;
tentatively accepting the meeting invitation;
rejecting the meeting invitation;
marking the meeting invitation as read; and
deleting the meeting invitation.

13. The system of claim 8, wherein the one or more properties are headers within the meeting invite.

14. The system of claim 8, wherein the calendar booking rule is stored in the meeting invite as one or more headers.

15. A computer-implemented method for processing a meeting invite, the method comprising:
receiving a meeting invite;
accessing a transport rule associated with the meeting invite, wherein the transport rule is comprised of a transport predicate, a transport action, and a calendar booking rule;
determining, based on the content of the meeting invite, whether the transport predicate is satisfied; and
when the transport predicate is satisfied, modifying the meeting invite based on the transport action, wherein modifying the meeting invite comprises associating the calendar booking rule with the meeting invite.

16. The computer-implemented method of claim 15, wherein the transport action comprises updating a header associated with the meeting invite to contain information associated with the calendar booking rule.

17. The computer-implemented method of claim 15, wherein the transport predicate specifies a sender associated with the meeting invite.

18. The computer-implemented method of claim 15, wherein the calendar booking rule comprises a calendar booking predicate and a calendar booking action.

19. The computer-implemented method of claim 15, wherein the calendar booking action comprises an action selected from the group consisting of:
accepting the meeting invitation;
tentatively accepting the meeting invitation;
rejecting the meeting invitation;
marking the meeting invitation as read; and
deleting the meeting invitation.

20. The computer-implemented method of claim 15, wherein associating the calendar booking rule with the meeting invite comprises storing the calendar booking rule in a header of the meeting invite.
